(19) United States
(12) Patent Application Publication
(10) Pub. No.: US 2025/0045006 A1
(43) Pub. Date: Feb. 6, 2025

(54) VEHICLE-MOUNTED DISPLAY SYSTEM

(71) Applicant: WUHAN CHINA STAR OPTOELECTRONICS TECHNOLOGY CO., LTD., Wuhan (CN)

(72) Inventor: Yang Feng, Wuhan (CN)

(73) Assignee: WUHAN CHINA STAR OPTOELECTRONICS TECHNOLOGY CO., LTD., Wuhan (CN)

(21) Appl. No.: 17/290,746

(22) PCT Filed: Mar. 31, 2021
(86) PCT No.: PCT/CN2021/084717

§ 371 Date: Jun. 10, 2024

(30) Foreign Application Priority Data
Mar. 25, 2021 (CN) 202110318283.4

(51) Int. Cl. G06F 3/14; B60R 16/023

(52) U.S. Cl. CPC G06F 3/1423; B60R 16/023

(57) ABSTRACT

A vehicle-mounted display system is provided. The vehicle-mounted display system includes a first display module configured to display first preset display information and a second display module configured to display second preset display information in a first display state. Wherein, when the first preset display information includes first target display information, the second display module is further configured to communicatively connect to the first display module to receive the first target display information, and configured to simultaneously display the second preset display information and the first target display information in a second display state.

### FIELD

The present application relates to a display technology, and in particular to a vehicle-mounted display system.

### BACKGROUND

Currently, interactive display contents of various display screens in cars are different. When driving, for safety, a driver's sight cannot leave road for a long time and divert back and forth between multiple screens. In addition, because display information on a screen that the driver pays attention to is limited in the prior art, the driver cannot obtain key display information in time.

### SUMMARY

### Technical Problem

The purpose of the present application is to provide a vehicle-mounted display system to ensure that a driver can obtain key information in time while prevent the driver's attention from being distracted when watching display information on split screens due to too many display screens in a cockpit.

### Problem Solution

### Technical Solution

A vehicle-mounted display system, including:
a first display module configured to display first preset display information; and
a second display module configured to display second preset display information in a first display state;
wherein when the first preset display information includes first target display information, the second display module is further configured to communicatively connect to the first display module to receive the first target display information, and configured to simultaneously display the first target display information and the second preset display information in a second display state.

### Beneficial Effects of Invention

### Beneficial Effects

A vehicle-mounted display system is provided. In this vehicle-mounted display system, a second display module displays second preset display information in a first display state, and while retaining second preset display information in a second display state, integrates first target display information in first preset display information displayed by a first display module into a second display module, to realize a function of one display module to display key display information of multiple display modules. This can ensure that a driver obtains the key display information of the multiple display modules in one display module, so as to prevent the driver's attention from being distracted when watching the screen information in split screens due to too many screens in a cockpit.

### BRIEF DESCRIPTION OF DRAWINGS

### Description of Drawings

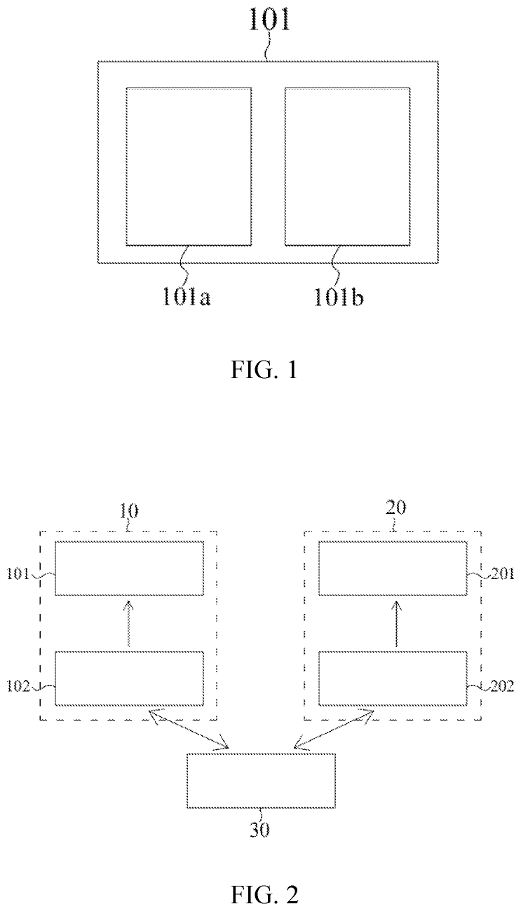

FIG. 1 is a schematic diagram of a first display screen of a first display module of the present application displaying first preset display information.

FIG. 2 is a schematic diagram of transmitting first target display information between the first display module and a second display module of the present application through a wireless communication module.

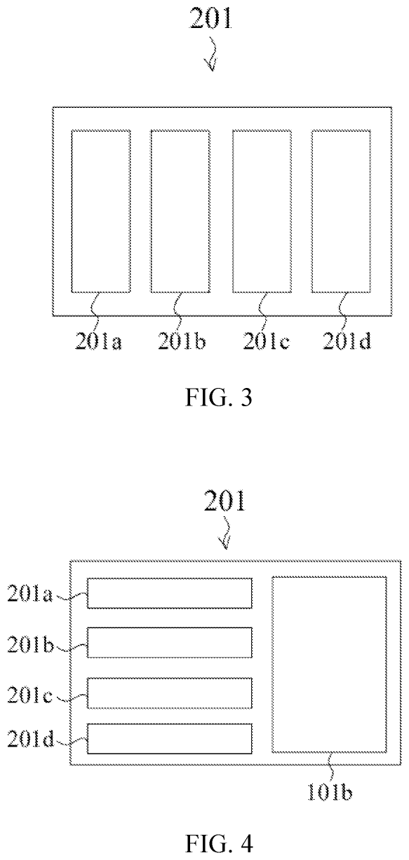

FIG. 3 is a schematic diagram of a second display screen of the second display module of the application displaying second preset information in a first display state.

FIG. 4 is a schematic diagram of the second display screen of the second display module of the present application displaying second preset display information and first target display information in a second display state.

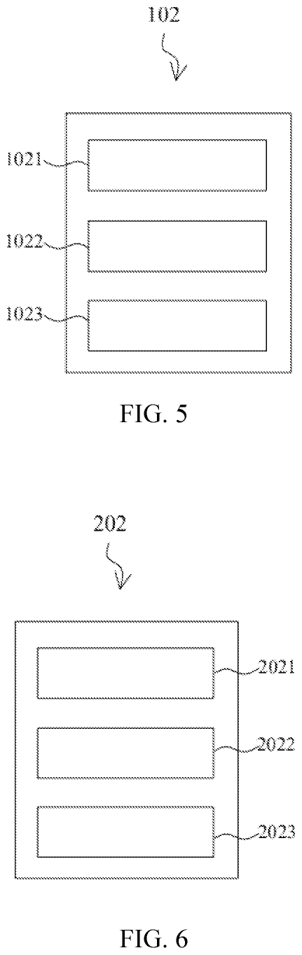

FIG. 5 is a schematic diagram of an architecture of a master controller of a first control unit shown in FIG. 2.

FIG. 6 is a schematic diagram of an architecture of a master controller of a second control unit shown in FIG. 2.

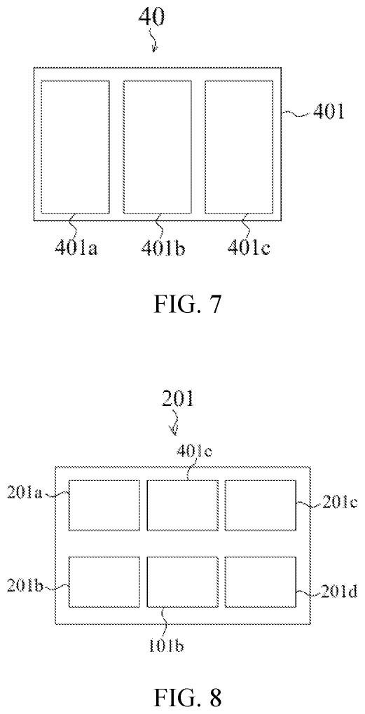

FIG. 7 is a schematic diagram of a third display screen of a third display module of the present application displaying third preset display information.

FIG. 8 is a schematic diagram of displaying second preset display information, first target display information, and second target display information on the second display screen of the second display module of the present application in a third display state.

### EMBODIMENTS OF INVENTION

### Detailed Description of Preferred Embodiments

The technical solutions in embodiments of the present application will be clearly and completely described below with reference to drawings in the embodiments of the present application. Obviously, the embodiments are only a part of the embodiments of the present application, rather than all the embodiments. Based on these embodiments in the present application, all other embodiments obtained by one of ordinarily skilled in the art without creative work shall fall within a protection scope of the present application.

A vehicle-mounted display system is provided. During a driving process, the vehicle-mounted display system connects key information displayed by at least one of display modules to a display module that a driver needs to pay attention to when driving through a wireless network. The display module that needs attention when driving displays original key information while also displaying key information transmitted by one or more other display modules. This can prevent a problem that the driver's sight needs to be shifted back and forth between multiple different display modules to obtain different key information during driving, which affects driving safety. Therefore, the purpose of assisting the driver to completely concentrate on driving is achieved.

The vehicle-mounted display system includes various display modules and a wireless communication module 30. A number of various display modules are arranged at different positions in the cockpit. The wireless communication module 30 is provided separately from each display module, and turning on and turning off of the wireless communication module is independently controlled.

In this embodiment, when the wireless communication module 30 is turned on, a connection of a display module to a wireless network is achieved by displaying a turn-on or turn-off button (for example, a turn-on/turn-off Wi-Fi button) on a display interface when the display module is working, and through a touch control module corresponding to a touch display module. The turn-on or the turn-off button can be the same button. When the display module is connected to the wireless network, click the button on a corresponding touch module to make the display module not connect to the wireless network, and when the display module is not connected to the wireless network, click the button to make the display module connected to the wireless network. In addition, each display module in a cockpit has a specific media access control (mac) address or an internet protocol (IP) address in a link, which is set through the prior art, and the wireless communication module 30 only allows display modules with a specific mac address or an IP address in the link to be connected to the wireless network. For example, the specific mac address includes a mac address of the display module in the cockpit.

In this embodiment, when the wireless communication module 30 is turned on, each display module is connected to the wireless network through the wireless network card, etc. For any two display modules that need to be connected in communication, one display module sends an encryption key to the other display module, and the other display module receives the encryption key and replies to a correct decryption key to the display module that sent the encryption key, so as to realize a mutual authentication between the two display modules, and then realize a communication connection. On the contrary, if the decryption key replied by the other display module is incorrect, the communication connection between the two display modules cannot be realized. Multiple display modules can access a wireless network through the wireless communication module 30 and communicate with each other after the mutual authentication. The multiple display modules can interact with each other for display information. At least one of the two display modules is not connected to the wireless network, and the communication between the two display modules can also be disconnected. When the communication connection between the multiple display modules is disconnected, the multiple display modules display independently.

In this embodiment, the wireless communication module 30 may be a Wi-Fi module, and the multiple display modules send and receive display information via the Wi-Fi. It can be understood that the wireless communication module may also be a 4G network, a 5G network, a Bluetooth network, a local area network, or an Ethernet network.

In this embodiment, each display module includes one display screen, and the display screen may be a liquid crystal display screen, an organic light-emitting diode display screen, a quantum dot display screen, or a display screen of the other type. It can be understood that each display module may also include multiple display screens. Each display module further includes a control unit that controls a display of the display screen, and the control unit includes a master controller.

In this embodiment, the multiple different display modules may include a center console display module, a main driving instrument module, a co-driver display module, an armrest display module, a head-up display (HUD) module, and a rear entertainment display module. Wherein, when the center console display module is independently displayed, the center console display module displays air-conditioning operating information, car radio information, car audio information, and GPS navigation information. When the main driving instrument module is independently displayed, the main driving instrument module mainly displays vehicle speed, instantaneous fuel consumption, fault reminder, main driving seat belt prompt information, and water temperature. When the co-driver display module is independently displayed, the co-driver display module mainly displays the co-driver's seat belt prompt information and air purifier status information. When the head-up display module displays independently, the head-up display module mainly displays vehicle speed, fuel gauge, instantaneous fuel consumption, and GPS navigation information. When the rear entertainment display module displays independently, the rear entertainment display module mainly plays videos, TVs, and games. It can be understood that the multiple display modules may also include other display modules.

In order to facilitate the description of this technical solution in the present application, the present application is described by taking an example where a vehicle-mounted display system includes a first display module 10, a second display module 20, a third display module 40, and a wireless communication module 30. Wherein, when the wireless communication module 30 is turned on, the first display module 10, the second display module 20, and the third display module 40 are connected to a wireless network. Any two display modules can communicate with each other by sending an encryption key and replying to a correct decryption key, respectively. The first display module 10 and the third display module 40 are display modules that are inconvenient or unaccustomed for the driver to watch when driving, but at least one of the first display module 10 or the third display module 40 displays target key display information that the driver pays attention to. The first display module 10 and the third display module 40 are any two of a rear entertainment display module, a co-driver display module, or a center console display module, respectively. The second display module 20 is a display module that the driver is accustomed to watching or convenient to watch and is relatively close to the driver when driving. The second display module 20 may be a head-up display module, a main driving instrument module, and the like. It can be understood that the number of the display modules in the present application may be three or more than three.

In this embodiment, the vehicle-mounted display system further includes a touch module electrically connected to the second display module 20. The touch operation may be a touch operation such as tapping, sliding, long press, and so on. The touch operation includes the touch operation for the driver to display target key display information on the second display module. The touch module can be externally mounted outside the second display module 20 or can be installed inside the second display module 20.

In this embodiment, as shown in FIG. 2, the first display module 10 includes a first display screen 101 and a first control unit 102 connected to the first display screen 101. The first control unit 102 includes a master controller, and the first control unit 102 is configured to control a display of the first display screen 101. The first display screen 101 and the first control unit 102 are connected by wires. The first display module 10 has a first display state, the first display module 10 is configured to display the first preset display information in the first display state, and the first preset display information is the key display information inherently displayed by the first display module 10. The first preset display information includes at least one of static information or dynamic information. The static information is information whose content does not change, and the dynamic information is information that is updated in real time.

Specifically, the first display module 10 is a co-driver display module, and the first preset display information includes co-driver seat belt prompt information, air purifier status information, and the like. As shown in FIG. 1, the first display screen 101 displays first preset display information A 101a and first preset display information B 101b. The first preset display information A 101a corresponds to the co-driver seat belt prompt information, and the second preset display information B 101b corresponds to the air purifier status information. The first preset display information A 101a and the first preset display information B 101b are arranged side by side on the first display screen 101, and proportions of display area of the first preset display information A 101a and the first preset display information B 101b on the first display screen 101 are the same. It can be understood that the proportions of the display area of the first display screen 101 of the first preset display information A 101a and the first preset display information B 101b can also be different.

In this embodiment, as shown in FIG. 2, the second display module 20 includes the second display screen 201 and the second control unit 202 connected to the second display screen 201. The second control unit 202 and the second display screen 201 are connected by wires. The second control unit 202 includes a master controller, and the second control unit 202 is configured to control a display of the second display screen 201. When the first display module 10 and the second display module 20 are in communication connection, the second control unit 202 is in communication connection with the first control unit 102 and operates independently, respectively. That is, the first control unit 102 can only control the first display screen 101, and the second control unit 202 can only control the second display screen 201.

In this embodiment, the second display module 20 has a first display state, a second display state, a third display state, and a fourth display state.

When in the first display state, the first display module 10 and the second display module 20 can access a wireless network through the wireless communication module 30, and then realize a communication connection through encryption, decryption, and mutual authentication processes. The communication connection between the first display module 10 and the second display module 20 can also be disconnected by letting at least one of the first display module 10 or the second display module 20 not have access to the wireless network. The first display state is a conventional display state, the second display module 20 displays second preset display information in the first display state, and the second preset display information is inherent key display information of the second display module 20.

Specifically, the second display module 20 is a head-up display module. In the first display state, as shown in FIG. 3, the second display screen 201 displays the second preset display information A 201a, the second preset display information B 201b, the second preset display information C 201c, and the second preset display information D 201d, wherein the second preset display information A 201a is vehicle speed per hour, the second preset display information B 201b is oil gauge, the second preset display information C 201c is GPS navigation information, and the second preset display information D 201d is instantaneous fuel consumption. The second preset display information A 201a, the second preset display information B 201b, the second preset display information C 201c, and the second preset display information D 201d are arranged side by side in a horizontal direction, and the second preset display information A 201a, the second preset display information B 201b, the second preset display information C 201c, and the second preset display information D 201d occupy an entire area of the second display screen 201.

When in the second display state, the third display state, and the fourth display state, the second display module 20 is connected with one or more other display modules through the wireless communication module 30. While the second display module 20 displays inherent display information, it also displays the target display information required by the driver and displayed by the other one or more display modules. That is, the second display module 20 in the second display state, the third display state, and the fourth display state realizes an integration of target key display information of different display modules.

In this embodiment, the second display module 20 is loaded with the in-vehicle linkage software. When the second display module 20 is in communication connection with other display modules, click on the in-vehicle linkage software to enter a first-level menu of the in-vehicle linkage software. The first-level menu includes names of other display modules that are communicatively connected with the second display module 20, and a second-level menu of a corresponding display module can be entered by selecting a corresponding display module on the touch module. The second-level menu includes preset information inherently displayed by a corresponding display module, and the preset information inherently displayed by the corresponding display module is selected to determine target key information that needs to be displayed by the second display module 20. After the second display module 20 sends a request instruction to display the target key information to the corresponding display module, and receives the target key information sent by the corresponding display module, the second display module 20 integrates the received target key display information of the other one or more display modules with the second preset display information, and simultaneously displays them on the second display module 20.

In this embodiment, when first preset display information includes first target display information, a communication connection is established between a first display module 10 and a second display module 20. The second display module 20 is further configured to receive first target display information, and simultaneously display second preset display information and first target display information in a second display state. When the second display module 20 and the first display module 10 are switched from a communication connection to a communication disconnection, the second display module 20 is switched from the second display state to a first display state.

Take the first target display information as the first preset display information B 101b as an example.

In this embodiment, after the wireless communication module 30 is turned on, the second display module 20 and the first display module 10 are connected to the wireless network through the wireless communication module 30, and the first display module 10 and the second display module 20 are mutually authenticated to achieve a communication connection. When a driving user needs to watch the first preset display information B 101b displayed by the first display module 10 on the second display module 20 during driving, by operating the in-vehicle linkage software on the second display module 20, the second display module 20 obtains an instruction that the driver needs to display the first preset display information B 101b. The second display module 20 transmits an instruction to display the first preset display information B 101b to the first display module 10, and the first display module 10 transmits the first preset display information B 101b as first target display information to the second display module 20 through the wireless network.

Then, as shown in FIG. 4, after the second display module 20 receives the first preset display information B 101b sent by the first display module 10 through the wireless Wi-Fi network, the second display module 20 integrates the first preset display information B 101b and the second preset display information into one image. The information displayed on the second display screen 201 is the second preset display information A 201a, the second preset display information B 201b, the second preset display information C 201c, the second preset display information D 201d, and the first preset display information B 101b. The second preset display information A 201a, the second preset display information B 201b, the second preset display information C 201c, and the second preset display information D 201d are arranged side by side in a vertical direction, and proportions of display area occupied by the second preset display information A 201a, the second preset display information B 201b, the second preset display information C 201c, and the second preset display information D 201d on the second display screen 201 is reduced. The first preset display information B 101b is located on one side of the second preset display information A 201a, the second preset display information B 201b, the second preset display information C 201c, and the second preset display information D 201d. It can be understood that the first preset display information B 101b may also be located in a middle position of the second display screen 201. The second preset display information A 201a, the second preset display information B 201b, the second preset display information C 201c, and the second preset display information D 201d may also be arranged in two rows. The first preset display information B 101b can also be located at a position of the second display screen 201 close to a main driving position for the convenience of the driver to watch.

In this embodiment, as shown in FIG. 5, a master controller of the first control unit 102 includes the first image processing unit 1021, the first communication authentication unit 1022, and the information sending unit 1023. As shown in FIG. 6, a master controller of the second control unit 202 includes the second image processing unit 2021, the second communication authentication unit 2022, and the information synchronization unit 2023. The first communication authentication unit 1022 and the second communication authentication unit 2022 can identify each other by sending an encryption key and replying to a decryption key, so as to realize a communication connection between the first display module 10 and the second display module 20. After the first control unit 102 receives that the second display module 20 needs to display first target display information, the first image processing unit 1021 is configured to obtain the first target display information from first preset display information displayed by the first display module 10. The information sending unit 1023 is configured to send the first target display information extracted to the master controller of the second control unit 202 through the Wi-Fi network. After the second control unit 202 receives the first target display information, the second image processing unit 2021 is configured to integrate the received first target display information and the second preset display information, wherein, the integration includes compressing the second preset display information and synthesizing the compressed second preset display information and the first target display information into one image. The information synchronization unit 2023 is configured to synchronously display the integrated first target display information and the second preset display information on the second display module 20.

It should be noted that functions of the first image processing unit 1021, the first communication authentication unit 1022, the information sending unit 1023, the second image processing unit 2021, the second communication authentication unit 2022, and the information synchronization unit 2023 can all be implemented using current technologies. In addition, the second image processing unit 2021 can also integrate target display information, second preset display information, and first target display information transmitted by one or more display modules other than the first display module 10 to the second display module 20, and then displayed on the second display module 20 by the information synchronization unit 2023.

In this embodiment, a display characteristic of the second preset display information on the second display module 20 in the first display state is different from a display characteristic of the second preset information on the second display module 20 in the second display state. That is, a display form of the second preset display information in the second display state has changed relative to a display form of the second preset display information in the first display state.

In this embodiment, the display characteristic includes at least one characteristic of an image to screen ratio, a display layout mode, a display position, or a display background. Wherein, the image to screen ratio is a ratio of an area corresponding to the display information area to an area of the display screen, the display layout mode is an arrangement sequence of multiple display information, and the display position is a position where the image is displayed on the display.

Specifically, because in the second display state, the second display screen 201 needs to display not only the content displayed in the first display state but also the first target display information required by the driving user, a proportion of the display area of the second preset display information in the first display state is greater than a proportion of the display area of the second preset display information in the second display state. In addition, the area occupied by the second preset display information in the second display state is reduced, and the display layout mode of the second preset display information also needs to be adjusted. The display layout mode of the second preset display information in the first display state is also different from the display layout mode of the second preset display information in the second display state. For example, a horizontal side-by-side arrangement in the first display state is adjusted to a vertical side-by-side arrangement in the second display state. The display position of the second preset display information on the second display screen 201 in the first display state is also different from the display position of the second preset display information on the second display screen 201 in the second display state.

In this embodiment, when the second display module 20 is in the second display state, a display characteristic of the first target display information on the second display module 20 is different from a display characteristic of the second preset display information on the second display module 20. For example, a proportion of the display area of the first target display information on the second display screen 201 is greater than a proportion of the display area of the second preset display information on the second display screen 201, so that the driver can more easily obtain the first target display information.

In this embodiment, a display characteristic of the first target display information on the second display module 20 is also different from a display characteristic of the first target display information on the first display module 10. For example, a proportion of the display area of the first target display information on the second display module 20 is greater than a proportion of the display area of the first target display information on the first display module 10.

In this embodiment, when the second display module 20 is in the second display state, whether the second display module 20 receives the first target display information sent by the first display module 10 can be realized by setting a software button for receiving data on the second display module 20. Touch the software button of the data receiving function to turn on the function of the second display module to receive the data sent by the first display module.

In addition, when the second display module is in the second display state, if the first target display information sent by the first display module to the second display module includes display information that needs to be updated in real-time, a master controller of the first control unit 102 and a master controller of the second control unit 202 carries out the functions of transmission and dynamic monitoring status through the TCP socket protocol. During this process, the master controller of the first control unit 102 continuously sends updated first target display information to the master controller of the second control unit 202, and the master controller of the second control unit 202 queries the updated first target display information sent by the master controller of the first control unit 102 to the second control unit 202 in the wireless network through TCP socket manner and determines whether it is necessary to update the updated first target display information sent by the first control unit 102 to the content displayed on the second display screen 201. Wherein, the ways of determining whether it is necessary to update the updated first target display information sent by the first control unit 102 to the content displayed on the second display screen 201 includes: By setting a corresponding control signal (for example, touch event reporting, etc.) in the first control unit 102 and sending it to the second control unit 202, and after confirming the reception of the updated first target display information through the touch control signal on the second display module 20, the second display screen 201 is turned on to receive the updated first target display information sent by the first control unit 102.

In this embodiment, as shown in FIG. 7, the third display module 40 includes a third display screen 401 and a third control unit (not shown) connected to the third display screen 401 by wire. The third control unit controls the third display screen 401 to emit light, and the third control unit operates independently of the first control unit 102 and the second control unit 202. The third display module 40 has a first display state, and the third display module 40 displays third preset display information in the first display state. The communication connection between the third display module 40 and the second display module 20 can be achieved through the communication connection method between the first display module 10 and the second display module 20 described above.

Specifically, the third display module 40 is the center console display module. The third display screen 401 of the third display module 40 displays the third preset display information A 401a, the third preset display information B 401b, and the third preset display information C 401c, wherein the third preset display information A 401a corresponds to the air-conditioning operating information, the third preset display information B 401b corresponds to car radio information, the third preset display information C 401c corresponds to car audio information, and the third preset display information A 401a, the third preset display information B 401b, and the third preset display information C 401c is arranged side by side.

In other embodiment of this application, when first preset display information displayed by the first display module 10 includes the first target display information and the third preset display information displayed by the third display module 40 includes the second target display information, a driver needs the second display module 20 to display the first target display information and the second target display information. For example, when the first target display information is the first preset display information B 101b, and the second target display information is the third preset display information C 401c, the second display module 20 can simultaneously display the first preset display information B 101b of the first display module 10 and the third preset display information C 401c of the third display module 40. Specifically, the first display module 10 transmits the first preset display information B 101b to the second display module 20 through the wireless communication module 30 in combination with the above method, and the third display module 40 transmits the third preset display information C 401c to the second display module 20 through the wireless communication module 30 in combination with the above method. The second display module 20 integrates the inherently displayed second preset display information with the first preset display information B 101b and the third preset display information C 401c and displays them on the second display module 20. At this time, the second display module 20 is in the third display state, as shown in FIG. 8. Wherein, when the second display module 20 receives the first target display information and the second target display information, the priority of the second display module 20 for receiving the first target display information may be higher than the priority of the second display module 20 for receiving the second target display information. That is, the second display module 20 receives the second target display information after receiving the first target display information. It is understandable that the second display module 20 may also display the first preset display information B 101b and the third preset display information C 401c in two separate steps. For example, the second display module 20 first communicates with the first display module 10 and disconnects from the third display module 40. In combination with the above method, the second display module 20 receives the first preset display information B 101b, and the second display module 20 displays the inherent second preset display information and the first preset display information B 101b. Then, after the second display module 20 disconnects from the first display module 10, the second display module 20 communicates with the third display module 40 again. In combination with the above method, the second display module 20 receives the third preset display information C 401c, and the second display module 20 displays the inherent second preset display information and the third preset display information C 401c. At this time, the second display module 20 is in the fourth display state. Wherein, the second display module 20 respectively displays the target display information displayed by the two other display modules in two separate steps. It can be ensured that the information inherently displayed by the second display module 20 occupies a larger display area.

It should be noted that in addition to the second display module 20 possibly having the second display state to the fourth display state, the first display module 10 and the third display module 40 may also have the second display state to the fourth display state.

The description of the above embodiments is only used to help understand the technical solutions and core ideas of the present application. Those of ordinary skill in the art should understand that they can still modify the technical solutions described in the embodiments, or equivalently replace some of the technical features. However, these modifications or replacements do not cause the essence of the corresponding technical solutions to deviate from the scope of the technical solutions of the embodiments of the present application.

What is claimed is:

1. A vehicle-mounted display system, comprising:
a first display module configured to display first preset display information; and
a second display module configured to display second preset display information in a first display state;
wherein, when the first preset display information comprises first target display information, the second display module is further configured to communicatively connect to the first display module to receive the first target display information and configured to simultaneously display the first target display information and the second preset display information in a second display state;
wherein, when the second display module and the first display module switch from a communication connection to a communication disconnection, the second display module is switched from the second display state to the first display state; and
wherein the vehicle-mounted display system further comprises a wireless communication module, and the wireless communication module is communicatively connected to the first display module and the second display module.

2. The vehicle-mounted display system according to claim 1, wherein the first display module comprises a first image processing unit configured to obtain the first target display information from the first preset display information displayed by the first display module, and the second display module comprises a second image processing unit configured to integrate the first target display information received and the second preset display information.

3. The vehicle-mounted display system according to claim 1, wherein the first display module further comprises an information transmission unit configured to transmit the first target display information, and the second display module further comprises an information synchronization unit configured to synchronize a display of the first target display information and a display of the second preset display information on the second display module.

4. The vehicle-mounted display system according to claim 1, wherein the first display module comprises a first display screen and a first control unit connected to the first display screen, and the second display module comprises a second display screen and a second control unit connected to the second display screen; and
wherein the first control unit and the second control unit operate independently.

5. The vehicle-mounted display system according to claim 1, wherein a display characteristic of the second preset display information on the second display module in the first display state is different from a display characteristic of the second preset display information on the second display module in the second display state.

6. The vehicle-mounted display system according to claim 5, wherein the display characteristic comprises at least one characteristic of an image to screen ratio, a display layout mode, a display position, or a display background.

7. The vehicle-mounted display system according to claim 1, further comprising:
a third display module configured to display third preset display information;
wherein, when the first preset display information comprises the first target display information and the third preset display information comprises second target display information, the second display module is further configured to communicatively connect to both the first display module and the third display module to receive the first target display information and the second target display information, and configured to simultaneously display the second preset display information, the first target display information, and the second target display information in a third display state.

8. The vehicle-mounted display system according to claim 1, further comprising a third display module configured to display third preset display information;
wherein, when the first preset display information comprises the first target display information and the third preset display information comprises second target display information, the second display module is configured to communicatively connect to the first display module, to communicatively disconnect from the third display module to receive the first target display information, and to enter the second display state, and the second display module is further configured to communicatively connect to the third display module to receive the second target display information after the second display module disconnects communication from the first display module, and configured to simultaneously display the second preset display information and the second target display information in a fourth display state.

9. The vehicle-mounted display system according to claim 1, further comprising a touch module connected to the second display module, wherein the touch module is configured to sense a touch operation of a user who needs to display the first target display information.

10. A vehicle-mounted display system, comprising:
a first display module configured to display first preset display information; and
a second display module configured to display second preset display information in a first display state;
wherein, when the first preset display information comprises first target display information, the second display module is further configured to communicatively connect to the first display module to receive the first target display information, and configured to simultaneously display the first target display information and the second preset display information in a second display state.

11. The vehicle-mounted display system according to claim 10, wherein the first display module comprises a first image processing unit configured to obtain the first target display information from the first preset display information displayed by the first display module; and
the second display module comprises a second image processing unit configured to integrate the first target display information received and the second preset display information.

12. The vehicle-mounted display system according to claim 10, wherein the first display module further comprises an information transmission unit configured to transmit the first target display information, and
the second display module further comprises an information synchronization unit configured to synchronize a display of the first target display information and a display of the second preset display information on the second display module.

13. The vehicle-mounted display system according to claim 10, wherein the first display module comprises a first display screen and a first control unit connected to the first display screen, and the second display module comprises a second display screen and a second control unit connected to the second display screen; and
wherein the first control unit and the second control unit operate independently.

14. The vehicle-mounted display system according to claim 10, wherein a display characteristic of the second preset display information on the second display module in the first display state is different from a display characteristic of the second preset display information on the second display module in the second display state.

15. The vehicle-mounted display system according to claim 14, wherein the display characteristic comprises at least one characteristic of an image to screen ratio, a display layout mode, a display position, or a display background.

16. The vehicle-mounted display system according to claim 10, further comprising:
a third display module configured to display third preset display information;
wherein, when the first preset display information comprises the first target display information and the third preset display information comprises second target display information, the second display module is further configured to communicatively connect to both the first display module and the third display module to receive the first target display information and the second target display information, and configured to simultaneously display the second preset display information, the first target display information, and the second target display information in a third display state.

17. The vehicle-mounted display system according to claim 10, further comprising a third display module configured to display third preset display information;
wherein, when the first preset display information comprises the first target display information and the third preset display information comprises second target display information,
the second display module is configured to communicatively connect to the first display module, to communicatively disconnect from the third display module to receive the first target display information, and to enter the second display state, and the second display module is further configured to communicatively connect to the third display module to receive the second target display information after the second display module disconnects communication from the first display module, and configured to simultaneously display the second preset display information and the second target display information in a fourth display state.

18. The vehicle-mounted display system according to claim 10, further comprising a touch module connected to the second display module, wherein the touch module is configured to sense a touch operation of a user who needs to display the first target display information.

19. The vehicle-mounted display system according to claim 10, further comprising a wireless communication module, wherein the wireless communication module is communicatively connected to the first display module and the second display module.

20. The vehicle-mounted display system according to claim 10, wherein, when the second display module and the first display module switch from a communication connection to a communication disconnection, the second display module is switched from the second display state to the first display state.
